(19) United States
(12) Patent Application Publication
(10) Pub. No.: US 2007/0260382 A1
(43) Pub. Date: Nov. 8, 2007

(54) Control System for a Vehicle

(75) Inventors: Gerhard Frey, Esslingen (DE); Harro Heilmann, Ostfildern (DE); Klaus-Dieter Holloh, Kernen (DE); Eilert Martens, Remshalden (DE); Christian Quinger, Schorndorf (DE); Andreas Schwarzhaupt, Landau (DE); Gernot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 10/578,191

(22) PCT Filed: Oct. 26, 2004
(86) PCT No.: PCT/EP04/12053

§ 371 Date: Jul. 3, 2007

(30) Foreign Application Priority Data
Nov. 5, 2003 (DE) 10351652.2

(51) Int. Cl. G06F 19/00; B60T 8/17

(52) U.S. Cl. 701/70; 303/20; 701/36; 701/78; 701/80

(57) ABSTRACT

A control system having an electronically controllable drive train. A coordination level is assigned to a system control device in which set point values are generated from state variables of the vehicle and from driver's wishes and actuation signals for actuating actuators are generated therefrom. An execution level is subordinate to the coordination level and has actuators for executing the actuation signal. An axle electronic module activates at least one brake actuator assigned to the vehicle axle, and is arranged in the region of the vehicle axle. The axle electronic module is connected to the coordination level in order to transmit set point values, and is designed to determine actuation signals from the set point values in order to control the respective axle actuator. The axle electronic module is connected to a controllable differential lock in order to transmit the actuation signals.

### BACKGROUND AND SUMMARY OF THE INVENTION

This application is a 371(c) National Phase filing of International patent application Ser. No. PCT/EP2004/012053, filed Oct. 26, 2004, which claims priority to German patent application Ser. No. 103 51 652.2, filed Nov. 5, 2003, the disclosures of which are hereby incorporated by reference in their entirety.

The present invention relates to a control system for a vehicle having an electronically controllable drive train.

German Patent document DE 100 32 179 A1 discloses a control system which operates with an electronically controllable drive train which includes at least a steering system, a brake system and a drive assembly of the vehicle. The control system has an input level with devices for inputting continuous predefined values of a driver and for converting the predefined values into set point value signals. The control system also includes a coordination level for converting the set point value signals into actuation signals which are implemented by actuators of the drive train. In other words, the control system has a control device which at the output end generates control signals for driving the drive train, from an input-end movement vector, said control device being coupled to the drive train in order to transmit the control signals and said drive train then processing the control signals in order to implement the driver's request, a so-called drive-by-wire system or X-by-wire system.

The patent documents US 2003/130782 A1, DE 198 38 336 A1 and DE 101 36 258 A1 disclose other control systems for means of transportation, in each case units of the vehicle being controlled by means of control devices.

German Patent document DE 100 46 832 A1 discloses a further control system which is suitable for controlling a vehicle which is equipped with an electronically controllable drive train. The vehicle data relating to the vehicle movement dynamics, time data, position data, driver-end activation signals and actuation signals for the drive train which are generated by a control device are stored in a memory device. Such a control system permits improved accident analysis.

The present invention is concerned with the problem of specifying an improved embodiment for a control system of the type mentioned at the beginning, with which embodiment in particular shorter control times are achieved.

The invention is based on the concept of providing, in a control system for a vehicle, having an electronically controllable drive train and a coordination level and an execution level which is subordinate to the coordination level, an axle electronic module which is designed to activate at least one brake actuator assigned to the vehicle axle, and is arranged in the region of a vehicle axle. The axle electronic module is connected here both to the coordination level and to axle actuators which are assigned to the vehicle axle, and receives, from the coordination level, set point values which are generated from driver's wishes and have the purpose of determining actuation signals for actuating the respective axle actuator.

The control system according to the invention has at least two control levels, specifically the coordination level which is assigned to a system control device and in which set point values are generated from state variables of the vehicle and from driver's wishes, and actuation signals or actuating actuators are generated therefrom, and the execution level which is subordinate to the coordination level, is assigned to the axle electronic module and has actuators for executing the actuation signals. It is essential to the invention here that the axle electronic module is provided for activating at least one brake actuator assigned to the vehicle axle, and is arranged in the region of the vehicle axle, and that the axle electronic module is connected to the coordination level in order to transmit set point values, and is designed to determine actuation signals from the set point values in order to control the respective axle actuator, the axle electronic module being connected to a controllable differential lock in order to transmit the actuation signals.

Accordingly, in contrast to previous control systems, the abovementioned axle-specific elements or systems are now controlled by the axle electronic module, whereas further actuators are controlled in the conventional way with control signals which are generated in the coordination level. The axle can be functionally tested by controlling the sensors, actuators and the axle electronic module on the axle or in the vicinity of the axle.

The solution according to the invention provides the large advantage of integrating or bundling all the control processes for axle-specific actuators in the axle electronic module and as a result separating them from the conventional control system. The axle electronic module which is arranged in the region of the vehicle axle is located in the direct vicinity of the axle actuators so that the line paths between the axle actuators and the axle electronic module are significantly shortened compared to the previous execution and as a result the required control times can also be shortened. Simple interconnection of the axle actuators to the axle electronic module is thus achieved, providing in particular advantages in the field of cabling and thus in the field of fabrication, and at the same time allowing the possibility of integrating at least some of the coordinating software for controlling axle-specific functions such as, for example, braking and/or locking of the differential, into the axle electronic module and thus into the execution level.

The local arrangement of the sensors, actuators and axle electronic modules thus eliminates the variance among the lines, as a result of which the lengths of lines and variants are reduced. In addition, installations which are defective from the outset are also avoided.

The axle electronic module can expediently comprise electronics and/or software and/or local control circuits for at least one of the following functions: braking, locking of a differential, pitching and/or rolling, regulating a ride level. As a result, a large number of axle-specific or chassis-specific electronic and/or software components and/or control circuits are integrated into the axle electronic module and thus permit a rapid reaction to changing data such as, for example, driver's wishes and/or state variables of the vehicle. Predictive algorithms which permit optimum adjustment with respect to consumption and driving comfort can additionally be programmed in the coordinating software.

According to one advantageous development of the solution according to the invention, the electronics and/or the software and/or the local control circuit for the brake function regulates at least one element from the following list: brake pressure, local ABS, ABS signal acquisition and processing, active wear adjustment for a vehicle brake, sensing of brake lining wear. This listing is intended to show that the electronics and/or the software and/or the local control circuit which regulates the brake function has a plurality of subfunctions, a number of which have been mentioned above. The axle electronic module is thus able to sense and control a large number of axle-specific characteristic values.

Further elements which can be controlled by the axle electronic module are, for example, a tire management system which calculates a coefficient of friction between the carriageway and tire, a lubricant management system for an axle differential and further axle-related actuators.

Further important features and advantages of the invention are apparent from the subclaims, from the drawing and from the associated description of the figures with reference to the drawing.

It is self-evident that the features which are mentioned above and which will be explained below can be used not only in the respectively specified combination but also in other combinations or in isolation without departing from the scope of the present invention.

A preferred exemplary embodiment of the invention is illustrated in the drawing and will be explained in more detail in the following description.

### BRIEF DESCRIPTION OF THE DRAWING

The single figure shows a schematic illustration of an embodiment of a control system according to the invention.

### DETAILED DESCRIPTION OF THE FIGURE

According to the figure, a control system 1 according to the invention for a vehicle has a plurality of signal processing levels. By way of example, a total of four levels are illustrated here, specifically an input level E, an intermediate level Z, a coordination level K and an execution level AE which is subordinate to the coordination level K. A driver enters predefined values in the form of driver's wishes FW into the input level E by, for example, activating operator control elements such as, for example, an accelerator pedal, a brake pedal or a steering wheel or keeping them in a specific position. The inputs here can be of a continuous or discrete nature.

Depending on the embodiment, the intermediate level Z which is illustrated in the figure can either comprise a single intermediate level Z or a plurality of levels, for example a prediction level and/or a correction level. It is also conceivable for the coordination level K to be arranged directly after the input level E and for the driver's wish FW to be transmitted directly from the input level E to the coordination level K.

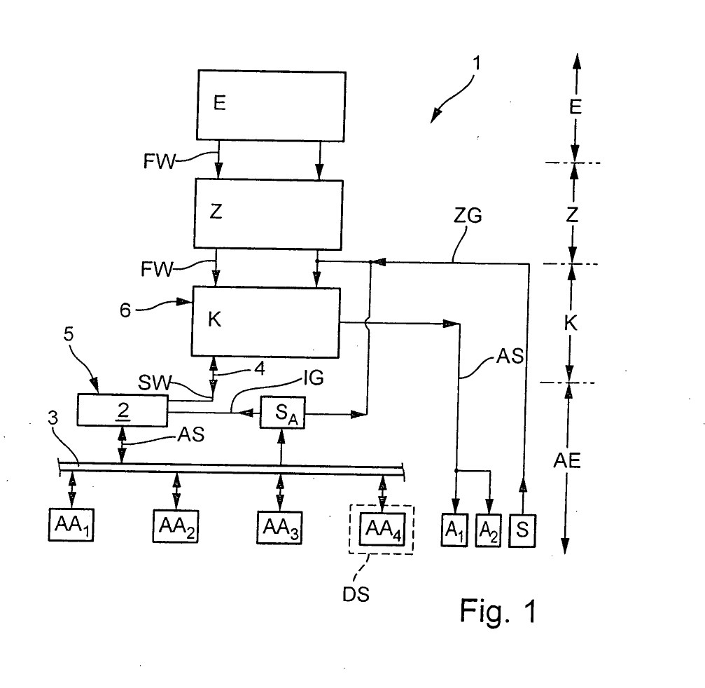

In the coordination level K, which is assigned to a system control device 6, set point values SW are generated from state variables ZG of the vehicle and from the driver's wishes FW and actuation signals AS for actuating actuators A are generated therefrom. The state variables ZG are transmitted from sensors S of the vehicle via a corresponding connection and reflect a natural state with respect to the driving situation. According to FIG. 1, the actuation signals AS which are generated by the coordination level K control actuators A which are arranged in the execution level AE and which are embodied, for example, as an actuator A₁ for a vehicle engine (not illustrated) and/or an actuator A₂ for a transmission (also not illustrated). The execution level AE is mounted downstream of the coordination level K in terms of control technology here.

The invention then provides for axle actuators AA, such as, for example, a brake actuator AA₁ or a ride level regulating actuator AA₂, to be activated and/or controlled by an axle electronic module 2. The axle electronic module 2 is part of an axle control device 5. The axle actuators AA are assigned to at least one vehicle axle 3 here. The axle electronic module 2 is connected to the coordination level K for transmitting set point values SW and is designed to determine actuation signals AS from the set point values SW in order to control the respective axle actuator AA. In order to generate the actuation signals AS, the axle electronic module 2 receives, on the one hand, predefined set point values SW from the coordination level K and actual variables IG from one or more sensors S_{A} which are designed to sense vehicle movement dynamic data. The set point values SW which are input on the input side of the axle electronic module 2 are generated from the driver's wishes FW and from state variables ZG in the coordination level K.

The actuation signals AS which are generated in the axle electronic module 2 control the assigned axle actuators AA. The exemplary sensor S_{A} which generates actual variables IG for the axle electronic module 2 can additionally be connected to other sensors S via a connecting line on the input side to the coordination level K and as a result transmit actual variables IG relating to a driving state both to the axle electronic module 2 and to the coordination level K.

The axle electronic module 2 can be connected via a CAN bus 4 to the coordination level K, in which case it is also conceivable for further connections, for example between the axle actuators AA and the axle electronic module 2 and/or the sensors S and the input side of the coordination level K, to be embodied as CAN bus lines.

According to the figure, the axle electronic module 2 is arranged near to the axle so that a control circuit between the axle electronic module 2, the axle actuators AA and the associated sensors S_{A} can be significantly shortened compared to the conventional control system. The solution according to the invention can significantly reduce the expenditure on cabling and the interconnection between individual axle actuators AA and the control system 1 can be significantly simplified. The axle electronic module 2 carries out functions which were originally located in the coordination level K and are now exported into the execution level AE by the removal of the axle electronic module 2 from the coordination level K.

The axle electronic module 2 can in the process comprise electronics and/or software and/or local control circuits for, for example, braking, differential lock DS pitching and/or rolling and/or regulating a ride level. The electronics and/or the software and/or the local control circuits for functions mentioned above can be implemented directly in situ in the electronic axle electronic module 2. A result which is optimum in terms of consumption and driving comfort can be achieved by means of predictive algorithms in the coordination level K and/or in the axle electronic module 2.

The electronics and/or the software and/or the local control circuit for the brake function in the axle electronic module 2 is designed here to control various elements such as, for example, a brake pressure, a local ABS, an active wear setting for the vehicle brakes or sensing of wear of the brake linings. This listing does not in any way claim to be complete but rather merely constitutes a selection of possible elements.

The interconnection via the CAN bus 4 at the same time permits, for example, simple interconnection of brakes and differential lock DS and thus permits high speed transverse differential lock switching. When the lock is switched on and a difference in rotational speed is detected, the lock can be immediately engaged. The lock can also be switched off under load by engine intervention and/or brake intervention while maintaining the driving stability. In addition, the differential lock DS can be designed as an ESP-compatible differential lock.

Furthermore, the axle electronic module 2 can comprise electronics and/or software and/or local control circuits for, for example, a tire management system, a lubricant management system for an axle differential, a tire pressure sensor or other axle-related actuators.

To summarize, the essential features of the solution according to the invention can be characterized as follows:

The invention provides for the provision, in a control system 1 for a vehicle having an electronically controllable drive train and a coordination level K as well as an execution level which is subordinate to the coordination level K, an axle electronic module 2 for activating at least one axle actuator AA which is assigned to a vehicle axle 3, the axle electronic module 2 being connected to the coordination level K in order to transmit set point values SW, and being designed to determine actuation signals AS from the set point values SW in order to control the respective axle actuator AA. The axle electronic module 2 is connected here to the axle actuators AA in order to transmit the actuation signals AS.

In contrast to conventional control systems, in the control system 1 according to the invention, at least some of the software or the electronics are arranged in the axle electronic module 2 and thus exported into the execution level AE from the coordination level K.

As a result of the arrangement of the axle electronic module 2 near to the axle, design advantages in terms of possible cabling and shortened switching time are achieved in the control circuits, thus providing an improved reaction capability of the control system 1.

The axle can be tested functionally by virtue of the arrangement of the sensors, actuators and of the axle electronic module 2 on the axle or in the vicinity of the axle. The following tests are possible: electronic wiring, pneumatic lines, sensor system, actuator system, electronic system, hardware and software. This relates to the brakes, the differential lock DS and all the other functions. The characteristic curves of the sensors can be learnt and the initial values and end values thus no longer need to be set manually. The axle can thus be tested completely and supplied to the vehicle assembly line in a parametrized form as a premounted and pretested unit.

The local arrangement of the sensors S, actuators A and axle electronic modules 2 eliminates the variance among the lines, both electric and pneumatic, which is caused by the connection of the vehicle axle to different vehicle frame heights. This reduces the lengths of the lines and variants. In addition, installations which are already defective from the outset are avoided. A further advantage is the reduction of plug-in connections.

Braking the wheel which is on the outside of a bend on one side places the axle in a virtually torque-free state (free of differential torques). In this state, the differential lock DS can then be activated. The torque-free state of the axle can be determined indirectly by means of the ABS sensor system, for example by evaluating a momentum rotational speed window on the wheels on the left and right sides while taking into account the elasticities of the axle, or can be determined directly by means of a torque sensor system or further (optical) methods. The computational determination of the torque-free state also permits a regulated brake intervention which is aimed at the requirement of relieving load on the axles. In order to increase the driving comfort, the torque, which is less available for propulsion owing to the braking of a wheel, can be built up by means of targeted intervention into the engine.

1-8. (canceled)

9. A control system for a vehicle having an electronically controllable drive train, comprising having a coordination level which can be assigned to a system control device and in which set point values are generated from state variables of the vehicle and from driver's wishes and actuation signals for actuating actuators are generated therefrom;
an execution level which is subordinate to the coordination level and has actuators for executing the actuation signals,
an axle electronic module for activating at least one brake actuator assigned to an axle of the vehicle, said axle electronic module arranged in the region of the vehicle axle, wherein the axle electronic module is connected to the coordination level in order to transmit said set point values, and determines actuation signals from the set point values in order to control a respective one of said at least one axle actuator, and wherein the axle electronic module is connected to a controllable differential lock in order to transmit the actuation signals.

10. The control system as claimed in claim 9, wherein the control system has an axle control device assigned to the execution level, and arranged in the region of the vehicle axle and containing the axle electronic module.

11. The control system as claimed in claim 9, wherein the axle electronic module has sensors for sensing the axle torques, and an actuator is provided for locking the differential, said actuator activating the differential lock when the axle torques reach a predetermined value.

12. The control system as claimed in claim 9, wherein the axle electronic module comprises at least one of electronics, and software, and local control circuits for at least one of braking, and locking of a differential, and pitching and rolling, and regulating a ride level.

13. The control system as claimed in claim 12, wherein said at least one of the electronics and the software and the local control circuit for the brake function regulates at least one element from the following list:
brake pressure,
local ABS,
ABS signal acquisition and processing,
active wear adjustment for a vehicle brake,
sensing of brake lining wear.

14. The control system as claimed in claim 12, wherein the differential lock is designed as an ESP-compatible differential lock.

15. The control system as claimed in claim 12, wherein said at least one of the electronics and the software and the local control circuit has a local algorithm at least one of the pitching and the rolling function.

16. The control system as claimed in claim 12, wherein the axle electronic module comprises at least one of electronics and software and local control circuits for at least one element from the following group:
tire management system,
lubricant management system for axle differential,
tire pressure sensor,
axle-related actuators.

17. The control system as claimed in claim 16 wherein the tire management system includes calculation of a coefficient of friction.

18. The control system as claimed in claim 10, wherein the axle electronic module has sensors for sensing the axle torques, and an actuator is provided for locking the differential, said actuator activating the differential lock when the axle torques reach a predetermined value.

19. The control system as claimed in claim 10, wherein the axle electronic module comprises at least one of electronics, and software, and local control circuits for at least one of braking, and locking of a differential, and pitching and rolling, and regulating a ride level.

20. The control system as claimed in claim 11, wherein the axle electronic module comprises at least one of electronics, and software, and local control circuits for at least one of braking, and locking of a differential, and pitching and rolling, and regulating a ride level.

21. The control system as claimed in claim 13, wherein the differential lock is designed as an ESP-compatible differential lock.

22. The control system as claimed in claim 13, wherein said at least one of the electronics and the software and the local control circuit has a local algorithm at least one of the pitching and the rolling function.

23. The control system as claimed in claim 14, wherein said at least one of the electronics and the software and the local control circuit has a local algorithm at least one of the pitching and the rolling function.

24. The control system as claimed in claim 13, wherein the axle electronic module comprises at least one of electronics and software and local control circuits for at least one element from the following group:
tire management system,
lubricant management system for axle differential,
tire pressure sensor,
axle-related actuators.

25. The control system as claimed in claim 14, wherein the axle electronic module comprises at least one of electronics and software and local control circuits for at least one element from the following group:
tire management system,
lubricant management system for axle differential,
tire pressure sensor,
axle-related actuators.
